(19) United States
(12) Patent Application Publication
(10) Pub. No.: US 2018/0359819 A1
(43) Pub. Date: Dec. 13, 2018

(54) COOKTOP AND METHOD OF OPERATION

(71) Applicant: Haier US Appliance Solutions, Inc., Wilmington, DE (US)

(72) Inventor: Paul Bryan Cadima, Crestwood, KY (US)

(21) Appl. No.: 15/615,894

(22) Filed: Jun. 7, 2017

(51) Int. Cl. H05B 6/12; H05B 6/06; H05B 1/02; F23D 14/04; F24C 3/08

(52) U.S. Cl. CPC H05B 6/1236; H05B 6/06; H05B 1/0266; H05B 2213/03; F24C 3/085; H05B 2213/06; F23D 14/045

(57) ABSTRACT

A cooktop appliance and methods of operation are provided herein. The cooktop appliance may include a panel, a burner, a burner input, and a controller. The panel may panel comprise a top surface and a bottom surface. The burner may extend at least partially above the top surface of the panel along a vertical axis. The burner input may be in operable communication with the burner. The light source may be positioned to selectively project a light emission above the top surface. The controller may be operably coupled to the light source.

### FIELD OF THE INVENTION

The present subject matter generally relates to cooktop appliances, and more particularly to methods of illuminating a burner of a cooktop appliance.

### BACKGROUND OF THE INVENTION

Generally, gas cooktop appliances include a plurality of gas burners mounted to a top surface of the appliance. In existing systems, it can be difficult to determine when a burner is active. At times, users may find it difficult to know if a burner has actually been ignited. This is especially true if a utensil, such as a pot or pan, has been placed over the burner. Many users have been forced to “listen” for the ignition of gas by an igniter at the burner. Moreover, it can be difficult to quickly visually determine the status of a burner without closely examining a control knob or the burner itself. In some systems, fiber optic cables or light pipes have been used to carry light to a section of the top cap of a gas burner. Other systems have placed lights radially outward from the burner. However, these arrangements can lead to potential gas leaks, difficulties during assembly, cleaning barriers, and interference with conduits supplying fuel to the burner assembly. Along with reducing overall reliability of the burner, these existing systems can greatly increase the expense and effort required to repair one or more portions of the appliance. Moreover, they may become difficult to see when a utensil is placed on or near the burner.

Accordingly, a cooktop appliance with features for clearly illuminating one or more burners would be useful. It would be advantageous to be able to illuminate a gas burner in a manner that ensures ease of assembly and does not inhibit cleaning. Useful systems may provide a reliable and quickly verifiable method of visually indicating or confirming that gas being supplied to a burner has been ignited. In turn, it would be desirable to provide a system and apparatus that addresses at least some of the problems identified above.

### BRIEF DESCRIPTION OF THE INVENTION

Aspects and advantages of the invention will be set forth in part in the following description, or may be obvious from the description, or may be learned through practice of the invention.

In one aspect of the present disclosure, a method of operating a cooktop is provided. The method may include detecting a flame at a burner; and initiating a flame illumination at a light source based on detecting the flame.

In another aspect of the present disclosure, a cooktop appliance is provided. The cooktop appliance may include a panel, a burner, a burner input, and a controller. The panel may panel comprise a top surface and a bottom surface. The burner may extend at least partially above the top surface of the panel along a vertical axis. The burner input may be in operable communication with the burner. The light source may be positioned to selectively project a light emission above the top surface. The controller may be operably coupled to the light source. The controller may further be configured to execute an illumination task. The illumination task may include detecting a flame at the burner, and initiating a flame illumination at the light source based on detecting the flame.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a top, perspective view of a cooktop appliance according to an example embodiment of the present disclosure.

FIG. 2 provides a front, cross-sectional view of the example cooktop appliance of FIG. 1.

FIG. 3 provides a top, cross-sectional perspective view of a cooktop appliance according to an example embodiment of the present disclosure.

FIG. 4 provides a bottom, cross-sectional perspective view of the example cooktop appliance of FIG. 3.

FIG. 5 provides a front, partially-exploded cross-sectional perspective view of a cooktop appliance according to an example embodiment of the present disclosure.

FIG. 6 provides a front, partially-exploded cross-sectional perspective view of a cooktop appliance according to an example embodiment of the present disclosure.

FIG. 7 provides a side, schematic view a portion of a cooktop appliance according to an example embodiment of the present disclosure.

FIG. 8 provides a top view of an example cooktop appliance according to an example embodiment of the present disclosure.

FIG. 9 provides a flow chart illustrating a method of operating a cooktop appliance in accordance with an example embodiment of the present disclosure.

FIG. 10 provides a flow chart illustrating a method of operating a cooktop appliance in accordance with an example embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In some aspects of the present disclosure, a cooktop appliance and illumination system is provided. Generally, and as will be described in detail below, the cooktop appliance may be configured to automatically activate or illuminate a light source of the illumination system when a flame is detected at corresponding burner.

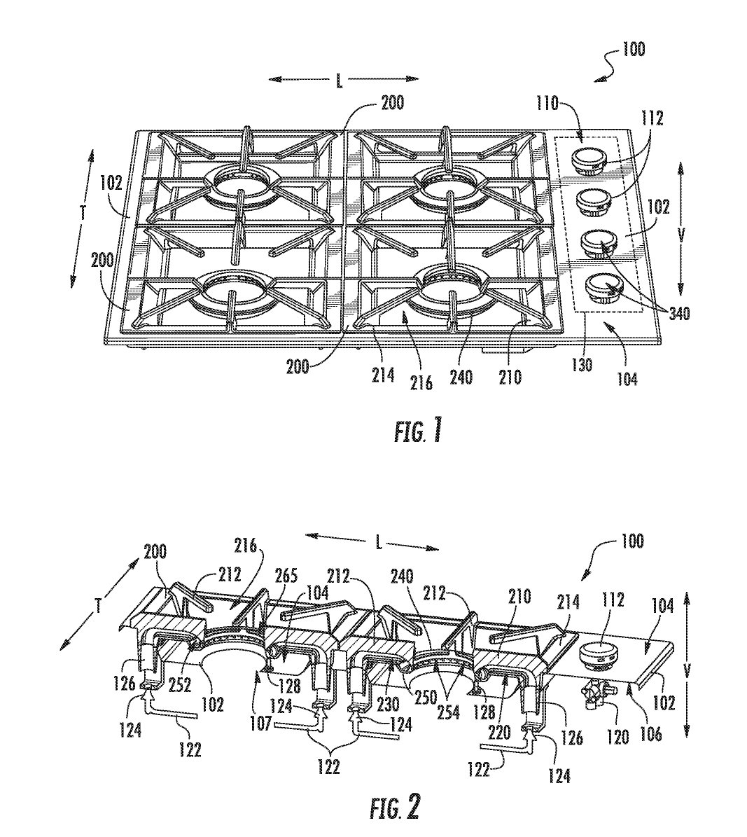

FIG. 1 illustrates an example embodiment of a cooktop appliance 100 as may be employed with the present disclosure. The example cooktop appliance 100 includes a panel 102 (e.g., a top panel) that extends in a lateral direction L and a transverse direction T. A top surface 104 and a bottom surface 106 of the panel 102 may be spaced apart along a vertical direction V (e.g., perpendicular to the lateral direction L and the transverse direction T). By way of example, the panel 102 may be constructed of enameled steel, stainless steel, glass, ceramics, and combinations thereof.

It is understood that cooktop appliance 100 is provided to generally illustrate example embodiments of the present disclosure. The example embodiments are not intended to limit the present subject matter to any particular appliance or cooktop arrangement. Thus, although described in the context of cooktop appliance 100, the present disclosure may be used in cooktop appliances having other configurations, e.g., a cooktop appliance with one, two, or any different number of burner assemblies. Similarly, the present disclosure may be used in cooktop appliances that include an oven (i.e., range appliances), or another suitable configuration.

For the cooktop appliance 100, a utensil holding food and/or cooking liquids (e.g., oil, water, etc.) may be placed onto one or more gas burner assemblies 200 at a location of any gas burner assembly 200. The gas burner assemblies 200 can be configured in various sizes so as to provide e.g., for the receipt of cooking utensils (i.e., pots, pans, etc.) of various sizes and configurations and to provide different heat inputs for such cooking utensils. In some embodiments, each gas burner assembly 200 includes a burner 240 supported on a top surface 104 of panel 102, as discussed in greater detail below. During use, the gas burner assemblies 200 generally provide thermal energy to cooking utensils above panel 102.

In some embodiments, a user interface panel 110 is located within convenient reach of a user of the cooktop appliance 100. For this example embodiment, the user interface panel 110 includes knobs 112 that are each associated with one of the gas burner assemblies 200. The knobs 112 allow the user to activate each burner assembly 200 and determine an amount of heat input provided by each gas burner assembly 200 to a cooking utensil located thereon. The user interface panel 110 may also be provided with one or more graphical display devices or light sources that deliver certain information to the user such as e.g., whether a particular burner assembly is activated and/or the level at which the burner assembly is set.

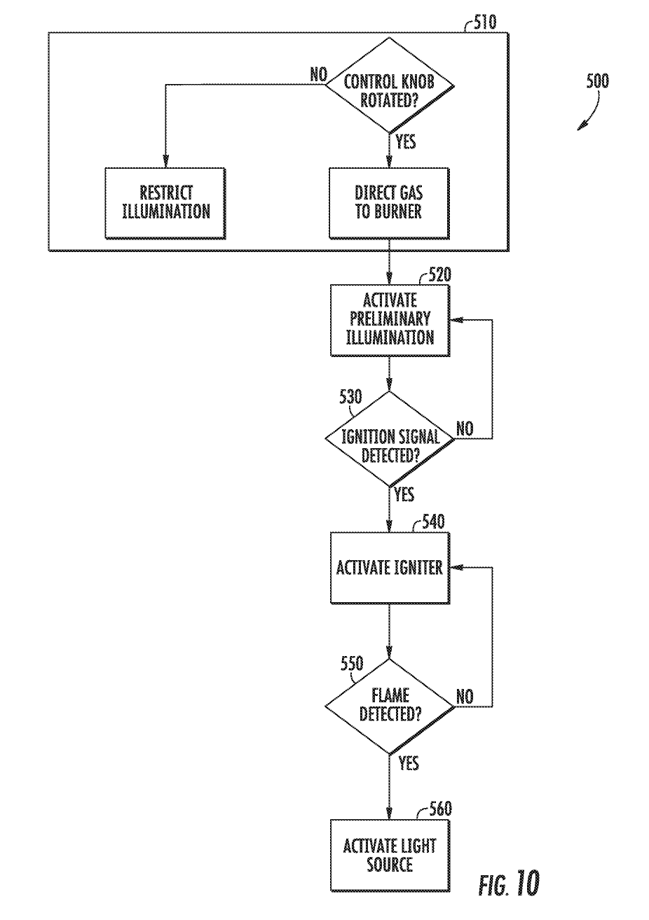

Referring now to FIGS. 1 through 6, operation of the cooktop appliance 100 can be regulated by a controller 130 that is operatively coupled (i.e., in operative communication) with the user interface panel 110, illumination system 300, and/or gas burner assemblies 200. For example, in response to user manipulation of the knobs 112 of user interface panel 110, the controller 130 operates one of the burners 240. Similarly, in response to user manipulation of the knobs 112 of the user interface panel 110, the controller 130 operates the illumination system 300. By way of example, the controller 130 may include a memory and one or more processing devices such as microprocessors, CPUs or the like, such as general or special purpose microprocessors operable to execute programming instructions or micro-control code associated with operation of appliance 100. The memory may represent random access memory such as DRAM, or read only memory such as ROM or FLASH. In one embodiment, the processor executes non-transitory programming instructions stored in memory. For certain embodiments, the instructions include a software package configured to operate appliance 100 and, e.g., execute an operation routine including the example methods 400 and 500 described below with reference to FIGS. 9 and 10. The memory may be a separate component from the processor or may be included onboard within the processor.

The controller 130 may be positioned in a variety of locations throughout appliance 100. In example embodiments, the controller 130 may be located under or next to the user interface panel 110. In such an embodiment, input/output (“I/O”) signals are routed between the controller 130 and various operational components of appliance 100, such as the gas burner assemblies 200, controls 112, illumination system 300, a graphical display, one or more sensors, and/or one or more alarms. In one embodiment, the user interface panel 110 may represent a general purpose I/O (“GPIO”) device or functional block.

Although shown with multiple knobs 112, it should be understood that knobs 112 and the configuration of the cooktop appliance 100 shown in FIGS. 1 through 6 are provided by way of example only. More specifically, the user interface panel 110 may include various input components, such as one or more of a variety of touch-type controls, electrical, mechanical or electro-mechanical input devices including rotary dials, push buttons, and touch pads. The user interface panel 110 may include other display components, such as a digital or analog display device designed to provide operational feedback to a user. The user interface panel 110 may be operably coupled with the controller 130 via one or more signal lines or shared communication busses. Furthermore, the user interface panel 110 may be located on a different surface of the appliance 100, for instance, an angled front edge or a vertical backsplash.

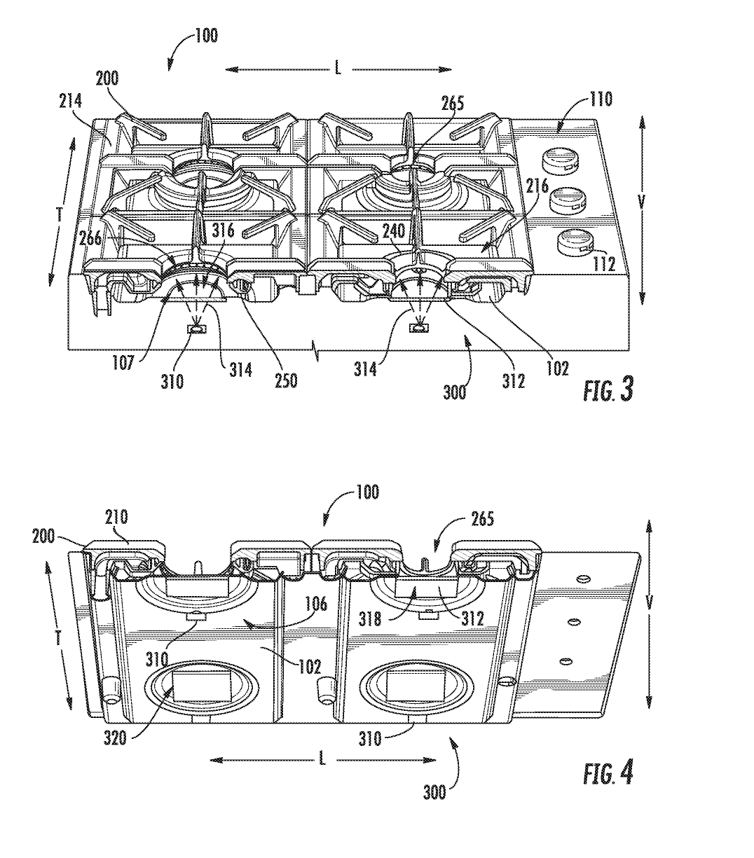

FIG. 2 provides a perspective, cross-sectional view of cooktop appliance 100. As seen in FIG. 2, in some embodiments, one or more gas burner assemblies 200 are removable from panel 102 of cooktop appliance 100. In certain example embodiments, no mechanical fastening connects gas burner assembly 200 to panel 102. Thus, each gas burner assembly 200 may be unfastened (i.e., not fastened) to panel 102, and a user may simply lift gas burner assembly 200 upwardly (in relation to the vertical axis V) to remove gas burner assembly 200 from panel 102, as shown in FIG. 2. In such a manner, top surface 104 of panel 102 below gas burner assembly 200 may be easily accessible and cleanable.

As shown in FIG. 2, the cooktop appliance 100 includes control valves 120, fuel lines 122, and fuel orifices 124. Control valves 120 may be mounted to panel 102 at a bottom surface 106 of panel 102. Fuel lines 122 and fuel orifices 124 may also be disposed below panel 120, e.g., at or adjacent the bottom surface 106 of panel 102. The control valves 120 are each coupled to a respective one of knobs 112. Thus, a user may adjust one or more of the control valves 120 with the knobs 112. The control valves 120 are configured for regulating fuel flow to the gas burner assemblies 200. For example, each control valve 120 blocks fuel flow to gas burner assemblies 200 when control valves 120 are closed. Conversely, each control valve 120 permits fuel flow to a gas burner assembly 200 when control valves 120 are open. A user may selectively adjust control valves 120 between the open and closed configurations with the knobs 112 in order to regulate fuel flow to gas burner assemblies 200.

Generally, it is understood that the fuel lines 122 may extend between control valves 120 and fuel orifices 124. Thus, the control valves 120 and fuel orifices 124 may be coupled to the fuel lines 122. When the control valves 120 are open, fuel, such as propane or natural gas, may flow through the fuel lines 122 to the fuel orifices 124. From the fuel orifices 124, fuel may flow into gas burner assemblies 200, where the fuel may be subsequently combusted. For instance, a static igniter 128 may be disposed on the panel 102 (e.g., within a burner ring 250) to combust or ignite fuel from a corresponding adjacent burner 240.

Between the fuel orifices 124 and the gas burner assemblies 200, fuel from the fuel orifices 124 may entrain and mix with air. The cooktop appliance 100 may include features for assisting mixing of air and fuel as fuel enters the gas burner assemblies 200. In particular, the example cooktop appliance 100 includes mixing tubes 126 that receive fuel and air, facilitating fluid mixing of the fuel and air. For example, the mixing tubes 126 may be Venturi mixers that define tapered channels such that a pressure of the fuel and air decreases while a velocity of the fuel and air increases. Other suitable means for mixing fuel and air are also contemplated and within the scope of the present disclosure. Downstream of the mixing tubes 126, the pressure of the fuel and air may increase while the velocity of the fuel and air decreases to further assist fluid mixing between the fuel and air entering the gas burner assemblies 200.

As shown in FIG. 2, each gas burner assembly 200 may include a grate 210 and a burner 240. The grate 210 is configured for supporting a cooking utensil, such as a pot, pan, etc. For example, the grate 210 of the example embodiment includes a plurality of elongated members 212 (e.g., formed of cast metal, such as cast iron). In turn, the cooking utensil may be placed on the elongated members 212 of the grate 210 such that the cooking utensil rests on an upper surface of elongated members 212. The elongated members 212 of the grate 210 may include an outer frame 214 that extends around or defines a perimeter of the grate 210 and/or gas burner assembly 200. Thus, the outer frame 214 may be disposed at an outer portion of the grate 210. When assembled, the grate 210 may rest on panel 102 at the outer frame 214. Thus, a bottom surface of outer frame 214 may rest on the top surface 104 of panel 102. As shown, the outer frame 214 of grate 210 may be square or rectangular in certain example embodiments. Within the outer frame 214, elongated members 212 define an inner passage 216 that extends vertically through grate 210 from the mixing chamber 126. Thus, fluid, such as air, may flow through grate 210 via inner passage 216.

In the example embodiment of FIG. 2, the burner 240 includes a burner ring 250 disposed on and fixed to the grate 210. Furthermore, the example burner ring 250 extends circumferentially about the central void 265. Both the burner ring 250 and grate 210 may be selectively removed from the panel 210 (e.g., during cleaning operations). The burner ring 250 has a fuel chamber 252 and a plurality of flame ports 254. As shown, the central void 265 extends uninterrupted from the top panel 102 to the region above the burner ring 250 and grate 210. The grate 210 defines a first internal fuel passage 220 and a second internal fuel passage 230. The first and second internal fuel passages 220, 230 are configured for directing fuel through the grate 210 to the burner 240. According to the illustrated example embodiment, the first internal fuel passage 220 and second internal fuel passage 230 are contiguous with the fuel chamber 252 of the burner ring 250. Thus, fuel from the fuel passages 220, 230 may flow into the fuel chamber 252 of the burner ring 250 and exit the fuel chamber 252 of the burner ring 250 at flame ports 254, where such fuel may be combusted. Although two fuel passages 220, 230 are shown, one skilled in the art will appreciate that only a single fuel passage may be needed according to alternative embodiments.

In addition, although the example embodiment of FIG. 2 shows the burner 240 having a single burner ring 250, the present disclosure is not so limited. For example, according to an alternative example embodiment, the burner 240 may be a multi-ring burner. For example, such a multi-ring burner may have an inner burner ring and an outer burner ring concentrically positioned such that outer burner ring extends around the inner burner ring. An inner fuel chamber may be separated from an outer fuel chamber by a wall within burner, and burner may be configured to supply fuel to a plurality of flame ports on the inner burner and outer burner, respectively. Optionally, if a multi-ring burner is used, each passage 220, 230 may be configured to provide fuel to a single ring of the multi-ring burner. Other configurations are also possible.

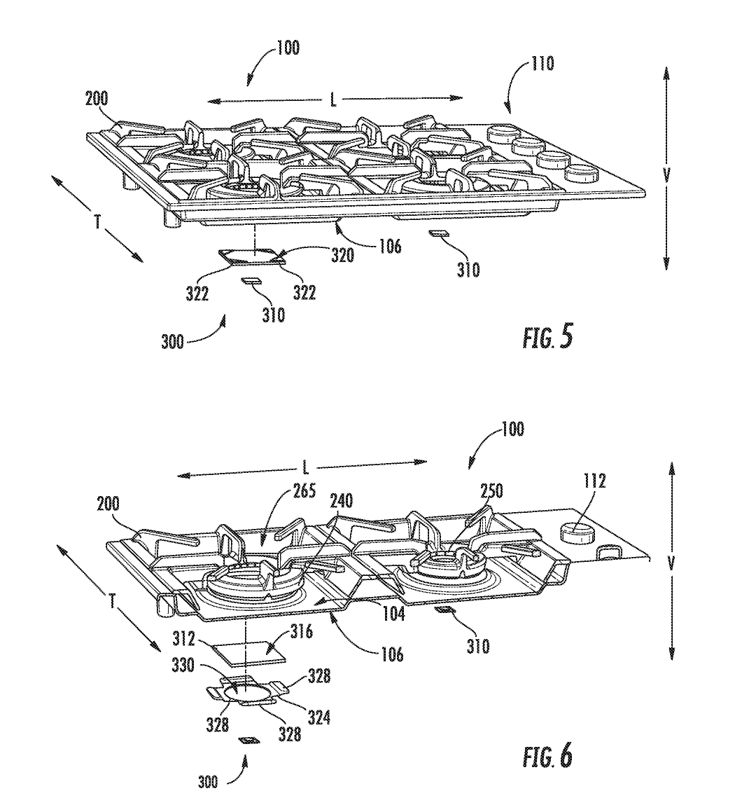

Turning to FIGS. 3 through 7, FIGS. 3 through 6 provide multiple cross-sectional perspective view of the cooktop appliance 100. FIG. 7 provides a side, schematic view the cooktop appliance 100. As shown, the top panel 102 defines an opening 107 extending along a vertical axis V between the top surface 104 and the bottom surface 106. In example embodiments, the opening 107 is vertically aligned with central void 265 and substantially concentric with the burner ring 250. As a result, the positions of the opening 107 and central void 265 at least partially overlap in both the lateral direction L and transverse direction T such that the central void 265 extends over the opening 107. In some example embodiments, the opening 107 is disposed directly beneath the central void 265 along the vertical axis V. In further embodiments, the opening 107 and central void 265 may share a common axis (i.e., be arranged as coaxial members). As concentric members, the opening 107 may be defined radially inward from a respective burner ring 250.

An illumination system 300 is provided with the gas burner assembly 200 in example embodiments. The illumination system 300 is generally mounted to the appliance 100 and operably coupled to controller 130. During operations, illumination system 300 serves as a visual indicator for certain functions thereof, as described in detail below.

Generally, the illumination system 300 provides a burner light source 310 attached to cooktop appliance 100. Optionally, multiple burner light sources 310 may be provided to generally correspond with separate gas burner assemblies 200. For instance, a corresponding burner light source 310 may be disposed beneath the gas burner assembly 200. In some such embodiments, the burner light source 310 is disposed beneath the panel 102 along the vertical axis V. Generally, the burner light source 310 is oriented or positioned to project light emission(s) 314 above the top surface 104 of the panel 102 (e.g., such that light emission(s) 314 are visible to a user looking down at appliance 100). In the example embodiments of FIGS. 3 through 7, burner light source 310 is directed towards and through the opening 107 in the top panel 102. In some such embodiments, a transmission plate 312 is further disposed beneath at least a portion of the gas burner assembly 200. The transmission plate 312 may be mounted to the panel 102 to receive one or more of the light emission(s) 314 from the burner light source 310. Once received, the transmission plate 312 may direct at least a portion of the emission(s) 314 through the opening 107 and above the top surface 104. In turn, activation of the burner light source 310, initiated by one or more user inputs (e.g., knobs 112 at the user interface panel 110), can selectively illuminate an area above the top surface 104.

Upon the burner light source 310 being activated (e.g., from controller 130), light emission(s) 314 may travel directly to the light transmission plate 312 before being directed to the area above the top surface 104. Specifically, light emission(s) 314 may be projected vertically through central void 265 and grate 210 before being visible above gas burner assembly 200. If a utensil is placed on the grate 210, light emission(s) 314 may be directed about the utensil's bottom surface 106 and to the edges of the grate 210 through the inner passage 216. Advantageously, the light emissions 314 may be readily visible to a user viewing the gas burner assembly 200.

In optional embodiments, the burner light source 310 is vertically aligned with the transmission plate 312. As a result, the positions of the burner light source 310 and the transmission plate 312 at least partially overlap in both the lateral direction L and transverse direction T such that the transmission plate 312 extends over the burner light source 310. In some example embodiments, the burner light source 310 is disposed directly beneath the transmission plate 312 along the vertical axis V. In further embodiments, the burner light source 310 and transmission plate 312 may share a common axis (i.e., be arranged as coaxial members). The space between the burner light source 310 and the transmission plate 312 may be unimpeded, advantageously simplifying assembly and preventing undesired light diffusion. Moreover, the burner light source 310 may be disposed at a suitable distance to avoid excessive or damaging heat from the gas burner assembly 200. Optional embodiments may further include a second or secondary light source 340. The second light source 340 may be spaced apart from burner light source 310. For instance, a secondary light source 340 may be positioned at corresponding burner input (e.g., adjacent to or on knob 112).

The light sources 310, 340 may generally include a suitable light generator, such as a fluorescent or incandescent bulb. In specific embodiments, the light source 310, 340 includes light emitting diode (LED). The LED can be configured as any suitable color. Optionally, the LED can be configured to vary one or more properties of the light emission(s) 314, such as color wavelength and/or illumination intensity (i.e., luminance or lumen value). In some such embodiments, controller 130 is configured to control or alter such properties based on one or more criteria.

In certain embodiments, controller 130 is configured to control or alter illumination (e.g., light emission(s) 314) at the light source 310 and/or 340 based on whether a flame has been generated by a corresponding burner assembly 200. Controller 130 may be operably (e.g., electrically) coupled to a flame sensor that is mounted proximate to burner ring 250. For instance, although any suitable flame detection sensor may be adopted, controller 130 may include a flame rectification circuit incorporating igniter probe (e.g., as shown at 128). As would be understood by one of ordinary skill in the art, a flame (e.g., at the flame ports 254) may act as a relatively weak rectifier and alter the flow of electrons and thereby the voltage of an alternating current through igniter probe 128, which acts as a flame rectification probe.

As a specific example, controller 130 may be configured to receive a signal from a burner input (e.g., when a specific knob 112 is rotated) indicating that burner is being activated. Once a flame is detected (e.g., at the igniter probe 128) controller 130 may initiate or activate, for example, the burner light source 310. Additionally or alternatively, the color wavelength and/or lumen value of light emission(s) 314 may be varied in correlation to a specific setting or settings, such as the positioning of knobs 112 and/or the heat output by the burner 240. Furthermore, one color wavelength and/or lumen value of light emission(s) 314 (e.g., a preliminary illumination) may be provided for indicating a knob 112 has been rotated from an inactive position, while another color wavelength and/or lumen value of light emission(s) 314 (e.g., a flame illumination) may be provided for indicating a flame has been detected. Advantageously, a readily-identifiable visual indication may be provided at the gas burner assembly 200 that a flame has been generated. A user may thus be prevented from having to listen for a flame ignition or look to another area of the cooktop appliance 100.

It is also understood, that a color wavelength and/or lumen value of the light emission(s) 314 can be further correlated to a heat or flame setting. Optionally, the lumen value (i.e., light intensity) can be further varied by the position of a knob 112. For example, when the knob 112 is in a low heat output position, the intensity of the burner light source 310 can be set at a low lumen value (i.e., wherein luminance is relatively low in relation to the maximum potential luminance level of the burner light source 310). When the knob 112 is placed in a high heat output position, the intensity of the burner light source 310 can be at a high lumen value (i.e., wherein luminance is relatively high in relation to the maximum potential luminance level of the burner light source 310). Between the low and high setting positions of the knob 112, the lumen value of the burner light source 310 can be varied accordingly.

In an additional or alternative embodiment, the color (i.e., wavelength of emitted light) of the burner light source 310 and light emission(s) 314 can be correlated to a heat or flame setting, e.g., such that color is varied according the position of the knob 112. At a low heat setting or position of knob 112, the burner light source 310 may have one wavelength color setting. At a next or higher heat setting of the knob 112, the burner light source 310 may have another different wavelength color setting.

In further additional or alternative embodiments, the burner light source 310 can also be used to indicate that a temperature of the cooktop and/or burner assembly 200 is hot, or at a temperature where user contact should be avoided. For instance, a temperature sensor or switch (not shown) can be disposed in communication with the burner light source 310 to control the on and off state, wavelength color setting, and lumen value of the burner light source 310.

As shown in FIGS. 3 through 7, the transmission plate 312 may be selectively mounted to the top panel 102 above the burner light source 310. Generally, the transmission plate 312 comprises one or more substantially transparent or translucent materials. Moreover, the material that forms the transmission plate 312 may be a suitable glass, ceramic, or polymeric material. For instance, in one embodiment, the transmission plate 312 is formed from a glass-ceramic material. Upon receiving light emission(s) 314 from the burner light source 310, at least a portion of the light emission(s) 314 may be directed through the transmission plate 312, while the remainder is reflected or absorbed by the plate 312 before reaching the opening 107.

As shown, an upper face 316 of the transmission plate 312 can be placed on or against the panel 102 while a lower face 318 is directed toward the burner light source 310 to receive emission(s) 314. The light transmission plate 312 may be defined along an outer perimeter 320 that is sized to have an area greater than that of the opening 107. In some example embodiments, the upper face 316 spans across the opening 107 of the panel 102 in both the lateral direction L and the transverse direction T. In turn, the transmission plate 312 may completely cover the cross sectional area of the opening 107, preventing the passage of most solids or liquids through the opening 107 to the area below the bottom surface 106 of the top panel 102. Optionally, the outer perimeter 320 may be attached to the bottom surface 106. In certain example embodiments, the perimeter 320 defines multiple corners 322, such as in a square or rectangle. When assembled, each corner 322 may engage the bottom surface 106.

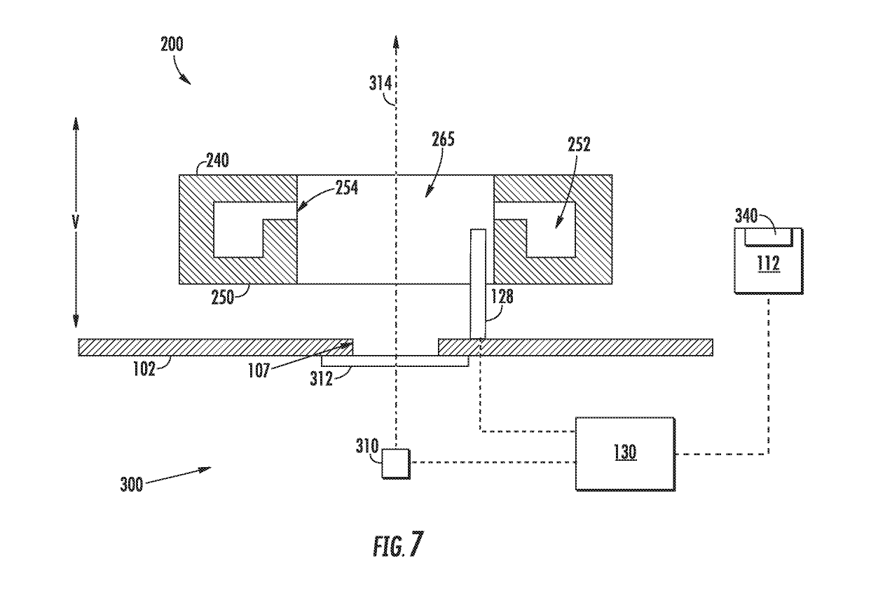

In optional example embodiments, the transmission plate 312 may be selectively mounted to the top panel 102, thus, allowing removal and reattachment of the transmission plate 312 to the top panel 102. Advantageously, a selectively removable configuration may allow users to readily access the burner light source 310 and clean/replace the light transmission plate 312. One or more suitable connectors may be provided to secure the transmission plate 312 to the appliance 100. In the embodiment of FIG. 5, an adhesive film is applied directly to each corner 322 of the upper surface. When placed on the bottom surface 106, the adhesive film may attach the transmission plate 312 to the portion of the bottom surface 106 surrounding the opening 107.

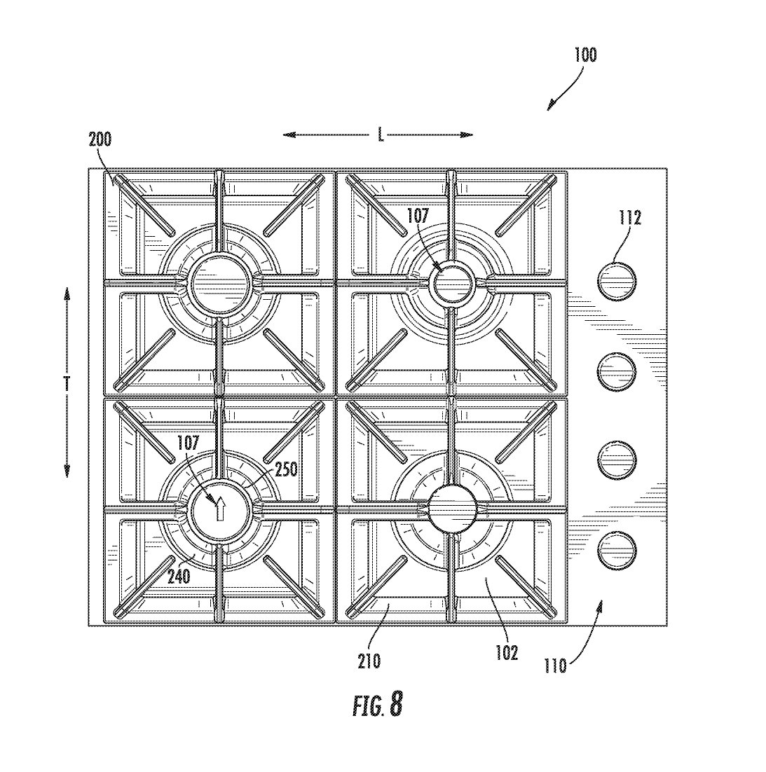

In additional or alternative embodiments, such as that provided in FIG. 6, a plate support bracket 324 selectively holds the light transmission plate 312 to the panel 102. In example embodiments, the plate support bracket 324 is attached to the bottom surface 106 and includes a pocket 326 to support the lower face 318 of the transmission plate 312. In certain example embodiments, the pocket 326 defines a recess in which the transmission plate 312 can rest. The pocket 326 may be generally open above the recess to receive the transmission plate 312 and permit the passage of light at the upper face 316. A hole 330 defined through the pocket 326 allows light emission(s) 314 to pass to the light transmission plate 312. One or more tabs 328 bound the pocket 326, and in turn, the transmission plate 312. When attached on the top panel 102, the tab(s) 328 engage the bottom surface 106, e.g., through an adhesive, mated hook, or other suitable mechanical attachment.

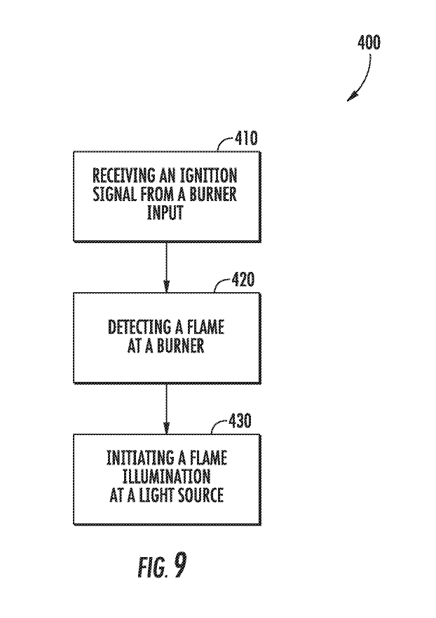

As noted above, the opening 107 defined by the panel 102 can be formed to have an area or profile that is smaller than that of the burner 240 and/or burner ring 250. For instance, the example embodiments illustrated in FIGS. 1 through 6 include multiple openings 107 defined within (i.e., radially inward from) respective burner rings 240. Some example embodiments of the opening 107 have a circular profile concentric to a respective burner ring 250. Alternative embodiments, such as that illustrated in FIG. 8, include one or more openings 107 that have a non-circular profile. For instance, one or more opening 107 may be defined to have a profile an arrow, square, or other suitable shape that is visible above the burner 240 and grate 210. Optionally, multiple discrete openings may be defined within a single burner ring 250.

Turning now to FIGS. 9 and 10, FIGS. 9 and 10 provide flow charts of methods 400 and 500 according to example embodiments of the present disclosure. Generally, the methods 400 and 500 provide methods operating a cooktop appliance 100. Specifically, methods 400 and 500 provides for controlling illumination of a cooktop appliance 100 (e.g., as an illumination task). As described above, the cooktop appliance 100 may include a panel 102, a burner 240 extending above a top surface 104 of the panel 102, and an illumination system 300 having a light source (e.g., burner light source 310) attached to the cooktop appliance 100 (e.g., oriented to selectively project or direct a light emission above the top surface 104). Additionally or alternatively, the illumination system 300 may have a second light source 340, for example, positioned at a burner input (e.g., knob 112), as described above. The methods 400 and 500 can be performed, for instance, by the controller 130. For example, controller 130 may, as discussed, be operably coupled with or to the illumination system 300. Moreover, controller 130 may send signals to and receive signals from the illumination system 300, one or more knobs 112, and/or a flame sensor (e.g., igniter probe 128). Controller 130 may further be in communication with other suitable components of the appliance 100 to facilitate operation of the appliance 100, generally.

It is understood that the methods 400 and 500 of FIGS. 9 and 10 may be performed independently, or may represent various steps of the same illumination task. Moreover, FIGS. 9 and 10 depict steps performed in a particular order for purpose of illustration and discussion. Those of ordinary skill in the art, using the disclosures provided herein, will understand that the steps of any of the methods disclosed herein can be modified, adapted, rearranged, omitted, or expanded in various ways without deviating from the scope of the present disclosure, except as otherwise indicated.

Turning specifically to FIG. 9, a flow chart is provided for the example method 400. At 410, the method 400 includes receiving an ignition signal from a burner input, such as a burner knob. For example, 410 may include detecting the relative or absolute rotational position of the burner knob. If the knob is detected within a predetermined ignition range, an ignition signal may be transmitted and subsequently received (e.g., at the controller). Other examples may include alternative steps or means to initiate transmission of the ignition signal. For instance, the burner knob may be engaged or moved axially (e.g., pushed towards the top panel along an axis of rotation). Moreover, a separate ignition switch or button may be provided and configured to transmit an ignition signal in response to engagement (e.g., by a user). In turn, 410 may include detecting axial movement of burner knob and/or engagement of a separate ignition switch.

At 420, the method 400 includes detecting a flame at the burner. In some embodiments, 420 may include receiving a flame signal from a flame sensor. For instance, as described above, a flame rectification probe (e.g., igniter probe) may gather information regarding the rectifying effect caused by a flame generated at the burner. Detection of a flame may thus cause the flame signal to be transmitted (e.g., to the controller).

At 430, the method 400 includes initiating a flame illumination at a light source (e.g., the burner light source). Specifically, 430, including the initiated flame illumination may be based on the detected flame. For instance, the initiated flame illumination of 430 may be performed in direct response to detection of the flame at 420. In other words, the flame illumination may be contingent upon a flame being detected at the burner. Once detected, the flame illumination may indicate the presence of the flame. In some embodiments, the flame illumination will direct a light emission through one or more portions of the burner assembly, as described above. Thus, a user may advantageously see or perceive light being transmitted through the burner grate, gas burner ring, and/or the transmission plate beneath which the burner light source is aligned. Moreover, a user may be able to advantageously determine a flame has been generated without having to listen for a flame ignition or look to another area of the cooktop appliance.

In optional embodiments, the method 400 further includes initiating a preliminary illumination. For instance, the method 400 may include determining the burner input has been engaged or moved from an inactive position (i.e., to an active gas-flowing position), and subsequently initiating a preliminary illumination based on that determination. The preliminary illumination may be provided, for example, by a light emission at a secondary light source (e.g., spaced apart from the burner light source on the burner knob, as described above).

Additionally or alternatively, preliminary illumination may be provided at the burner light source. However the preliminary illumination may differ (e.g., in color or intensity) from the subsequent flame illumination. For example, the preliminary illumination may include a first lumen value while the flame illumination includes a second lumen value. Optionally, the second lumen value may be greater that the first lumen value (i.e., such that the burner light source shines brighter at the flame illumination). As another example, the preliminary illumination may include a first wavelength color setting while the flame illumination includes a second wavelength color setting that is different from the first wavelength color setting. Thus, as the flame is detected, the light emissions may change from one visually-perceptible color (i.e., the first wavelength color setting) to another visually-perceptible color (i.e., the second wavelength color setting).

Turning now to FIG. 10, a flow chart is provided for the example method 500. At 510, the method 500 includes determining whether a control knob has been rotated. The determination may be made, for instance, if an active gas control signal is detected. If the control knob has not been rotated, illumination of the burner light source may be restricted. In other words, the burner light source may be maintained in a dimmed or unilluminated state (e.g., wherein no light emissions generated at the burner light source). If the control knob has been rotated, gas may be directed to the burner, e.g., through a gas valve in selective fluid communication with the burner, and method 500 may proceed to 520.

At 520, the method 500 includes activating preliminary illumination of a light source in response to gas being directed to the burner. For instance, the burner light source may be activated to direct a light emission above the top surface. Additionally, the light emission may be directed through the burner grate, gas burner ring, and/or the transmission plate beneath which the burner light source is aligned. Additionally or alternatively, the secondary light source may be activated (e.g., at a position spaced apart from the burner light source on the burner knob, as described above). The preliminary illumination may include a first lumen value and a first color wavelength setting, e.g., to provide a predetermined light intensity and color.

At 530, the method 500 includes detecting an ignition signal. For example, 530 may include detecting the relative or absolute rotational position of the burner knob. If the knob is detected within a predetermined ignition range, an ignition signal may be transmitted and subsequently received (e.g., at the controller). Other examples may include alternative steps or means to initiate transmission of the ignition signal. For instance, the burner knob may engaged or moved axially (e.g., towards the top panel along an axis of rotation). Moreover, a separate ignition switch or button may be provided and configured to transmit an ignition signal in response to engagement (e.g., by a user). In turn, 530 may include detecting axial movement of burner knob and/or engagement of a separate ignition switch. The detection of 530 may include repeatedly interrogating (e.g., according to a predetermined interval) an input (e.g., burner knob, user interface, etc.) or waiting for a transmitted signal therefrom.

At 540, the method 500 includes activating the igniter in response to receiving the ignition signal. For instance, the igniter or igniter probe may be directed to repeatedly generate an electrical spark discharge to incite combustion of the gas being directed to and from the burner.

At 550, the method 500 includes detecting a flame at the burner. The detection of 550 may include repeatedly interrogating (e.g., according to a predetermined interval) a flame sensor or waiting for a transmitted signal therefrom. For instance, as described above, a flame rectification probe (e.g., igniter probe) may gather information regarding the rectifying effect caused by a flame generated at the burner. If a flame is not detected, the method 540 may repeat or return to 540 to again activate the igniter to generate an electrical spark or discharge.

At 560, the method 500 includes activating a light source (e.g., the burner light source). Specifically, 560 includes initiating a flame illumination based on the detected flame. Once detected, the flame illumination may provide an easily perceived visual indicate the presence of the flame. The flame illumination may direct a light emission above the top surface, as described above. For instance, the light emission may be directed through one or more portions of the burner assembly. Thus, a user may advantageously see or perceive light being transmitted through the burner grate, gas burner ring, and/or the transmission plate beneath which the burner light source is aligned. Moreover, a user may be able to advantageously determine a flame has been generated without having to listen for a flame ignition or look to another area of the cooktop appliance.

In some embodiments, the flame illumination may include a second lumen value and a second color wavelength setting, e.g., to provide another predetermined light intensity and color. The second lumen value and/or second color wavelength may differ from the first lumen value and first color wavelength, respectively. Thus, the color and/or intensity of light from the burner light source may be varied upon a flame being detected. Moreover, in optional embodiments, 560 may include deactivating the igniter to continue burner operations.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a cooktop appliance, the cooktop appliance comprising a panel comprising a top surface and a bottom surface, a burner extending above the top surface of the panel along a vertical axis, a light source attached to the cooktop appliance, the method comprising:
detecting a flame at the burner; and
initiating a flame illumination at the light source based on detecting the flame.

2. The method of claim 1, further comprising:
determining engagement of the burner input from an inactive position; and
initiating a preliminary illumination at the light source based on determining engagement of the burner input.

3. The method of claim 2, wherein the preliminary illumination comprises a first lumen value, and wherein the flame illumination comprises a second lumen value greater that the first lumen value.

4. The method of claim 2, wherein the preliminary illumination comprises a first wavelength color setting, and wherein the flame illumination comprises a second wavelength color setting, the second wavelength color setting being different from the first wavelength color setting.

5. The method of claim 1, wherein the light source is a first light source, and wherein the method further comprises:
determining engagement of a burner input from an inactive position; and
initiating a preliminary illumination at a second light source based on determining engagement of the burner input, the second light source being spaced apart from the first light source.

6. The method of claim 5, wherein the second light source is positioned at the burner input.

7. The method of claim 1, wherein the light source is vertically aligned beneath a burner grate, and wherein initiating the flame illumination comprises directing a light emission through the burner grate.

8. The method of claim 1, wherein the burner comprises a gas burner ring extending circumferentially about a central void, wherein the transmission plate is vertically aligned with the central void, and wherein initiating the flame illumination comprises directing a light emission through the gas burner ring.

9. The method of claim 1, wherein detecting the flame comprises receiving a flame signal from a flame rectification probe mounted adjacent to burner.

10. The method of claim 1, wherein initiating the flame illumination comprises directing a light emission through a transmission plate mounted to the panel beneath the burner.

11. A cooktop appliance comprising:
a panel comprising a top surface and a bottom surface;
a burner extending at least partially above the top surface of the panel along a vertical axis;
a burner input in operable communication with the burner;
a light source positioned to selectively project a light emission above the top surface; and
a controller operably coupled to the light source, the controller configured to execute an illumination task, the illumination task comprising
detecting a flame at the burner, and
initiating a flame illumination at the light source based on detecting the flame.

12. The cooktop appliance of claim 11, wherein the illumination task further comprises
determining engagement of the burner input from an inactive position, and
initiating a preliminary illumination at the light source based on determining engagement of the burner input.

13. The cooktop appliance of claim 12, wherein the preliminary illumination comprises a first lumen value, and wherein the flame illumination comprises a second lumen value greater that the first lumen value.

14. The cooktop appliance of claim 12, wherein the preliminary illumination comprises a first wavelength color setting, and wherein the flame illumination comprises a second wavelength color setting, the second wavelength color setting being different from the first wavelength color setting.

15. The cooktop appliance of claim 11, wherein the light source is a first light source, wherein the cooktop appliance further comprises a second light source spaced apart from the first light source, and wherein the illumination task further comprises
determining engagement of the burner input from an inactive position, and
initiating a preliminary illumination at the second light source based on determining engagement of the burner input.

16. The cooktop appliance of claim 15, wherein the second light source is positioned at the burner input.

17. The cooktop appliance of claim 11, further comprising a burner grate extending at least partially above the burner, wherein the light source is vertically aligned beneath the burner grate, and wherein initiating the flame illumination comprises directing the light emission through the burner grate.

18. The cooktop appliance of claim 11, wherein the burner comprises a gas burner ring extending circumferentially about a central void, wherein the transmission plate is vertically aligned with the central void, and wherein initiating the flame illumination comprises directing the light emission through the gas burner ring.

19. The cooktop appliance of claim 11, further comprising a flame rectification sensor mounted adjacent to the burner, wherein detecting the flame comprises receiving a flame signal from the flame rectification sensor.

20. The cooktop appliance of claim 11, further comprising a transmission plate mounted to the panel, wherein the transmission plate comprises an upper face disposed beneath the bottom surface, and wherein initiating the flame illumination comprises directing the light emission through the transmission plate beneath the burner.
